(19) United States
(12) Patent Application Publication
(10) Pub. No.: US 2026/0131389 A1
(43) Pub. Date: May 14, 2026

(54) BANDSAW WHEEL WITH ENHANCED VIBRATION DAMPENING

(71) Applicant: Richard O. Rose, Houston, TX (US)

(72) Inventor: Richard O. Rose, Houston, TX (US)

(21) Appl. No.: 19/032,156

(22) Filed: Jan. 20, 2025

Related U.S. Application Data
(60) Provisional application No. 63/550,341, filed on Feb. 6, 2024.

(51) Int. Cl. B23D 55/06; B23D 55/00

(52) U.S. Cl. CPC B23D 55/065; B23D 55/005

(57) ABSTRACT

A bandsaw wheel may include a hub, a rim, and an intermediate body. The intermediate body may extend between and connect the hub and the rim. The hub, the rim, and the intermediate body may be provided as separate, individual components.

### CROSS-REFERENCE TO RELATED APPLICATIONS

This application claims priority to U.S. Provisional Patent Application No. 63/550,341, filed on Feb. 6, 2024, the contents of which is hereby incorporated by reference in its entirety.

### TECHNICAL FIELD

The present invention relates to bandsaws and, more particularly, to a composite bandsaw wheel with enhanced vibration dampening and/or reduced harmonics and noise.

### BACKGROUND

A bandsaw is a machine or apparatus that commonly includes one or more motors, a plurality of bandsaw wheels, and at least one blade. The blade is typically serrated (i.e., includes serrations and/or teeth) and is structured as continuous flat band of material (typically metal) that forms a loop. The blade is journaled over (e.g., looped around under tension to at least some extent) two or more spaced-apart bandsaw wheels that rotate in the same plane (i.e., rotate about substantially parallel wheel axes). Typically, one of the bandsaw wheels is powered, actuated, and/or rotated by an electric motor or belt system (e.g., via a drive shaft thereof), which rotates the blade around the two wheels and/or a blade axis extending parallel to the two wheel axes. The blade can come in a variety of configurations (e.g., lengths, widths, thicknesses, material compositions, serration/tooth shapes, serration/tooth sizes, serration/tooth patterns, etc.), which enables the bandsaw to be modified, adjusted, and/or customized to, for example, cut a wide variety of materials (e.g., wood, metal, and/or plastic).

Existing bandsaw wheels are typically composed of metal (e.g., steel) and integrally formed via casting or flame cutting, for example. One of the problems with existing bandsaw wheels is that vibrations from the sawing process are readily transferred into the bandsaw wheels via the bandsaw blade, causing harmonic vibrations that increase the amount and/or level of noise produced by the bandsaw during the sawing process.

Accordingly, there is a need for an improved bandsaw wheel that minimizes or eliminates one or more challenges or shortcomings of existing bandsaw wheels.

### SUMMARY

The present disclosure relates to bandsaws and, more particularly, to a composite bandsaw wheel with enhanced vibration dampening and/or reduced harmonics and noise. To solve and/or mitigate the problem of undesired vibration transfer and/or high-level noise generation of bandsaws during operation, the disclosed bandsaw wheel provides enhanced and/or improved vibration dampening, which in turn reduces resonance, harmonics, and noise during the sawing process.

In examples, a bandsaw wheel may include a hub, a rim, and an intermediate body. The intermediate body may extend between and connect the hub and the rim. The hub, the rim, and the intermediate body may be structured as separate, individual components.

In examples, the hub may be composed of a first material. The intermediate body may be composed of a second material. The rim may be composed of a third material. The intermediate body may extend between and connect the hub and the rim. At least two of the hub, the intermediate body, and the rim may be comprised of different materials.

In examples, a method of manufacturing a bandsaw wheel may include (i) providing a hub, an intermediate body, and a rim and (ii) forming a wheel assembly. The hub, the intermediate body, and the rim may be structured as separate, individual components. Forming the wheel assembly may include connecting the hub, the intermediate body, and the rim. Connecting the hub, the intermediate body, and the rim may include (i) connecting the intermediate body and the rim to one another and/or (ii) connecting the intermediate body and the hub to one another.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view of an embodiment of a bandsaw wheel according to aspects or teachings of this disclosure;

FIG. 2 is a perspective, partial view of an embodiment of a bandsaw according to aspects or teachings of this disclosure including the bandsaw wheel of FIG. 1;

FIG. 3 is a front view of an embodiment of a bandsaw according to aspects or teachings of this disclosure, including the bandsaw wheel of FIG. 1; and

FIG. 4 is an exemplary method of manufacturing a bandsaw wheel.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

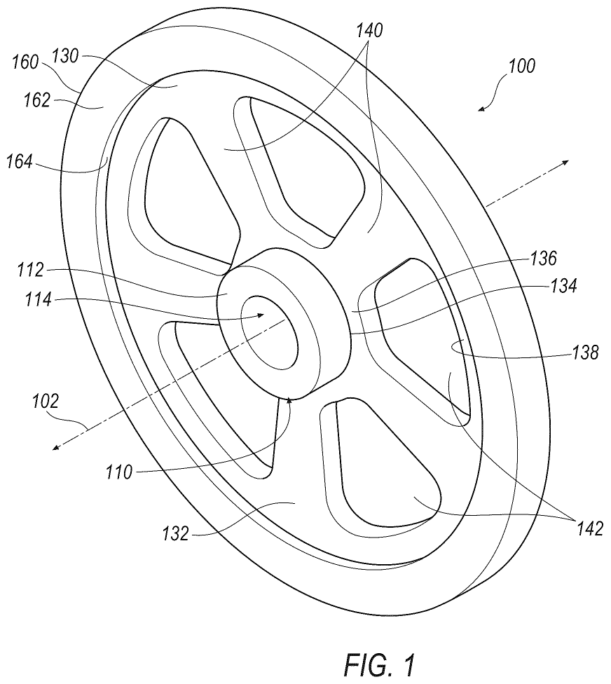

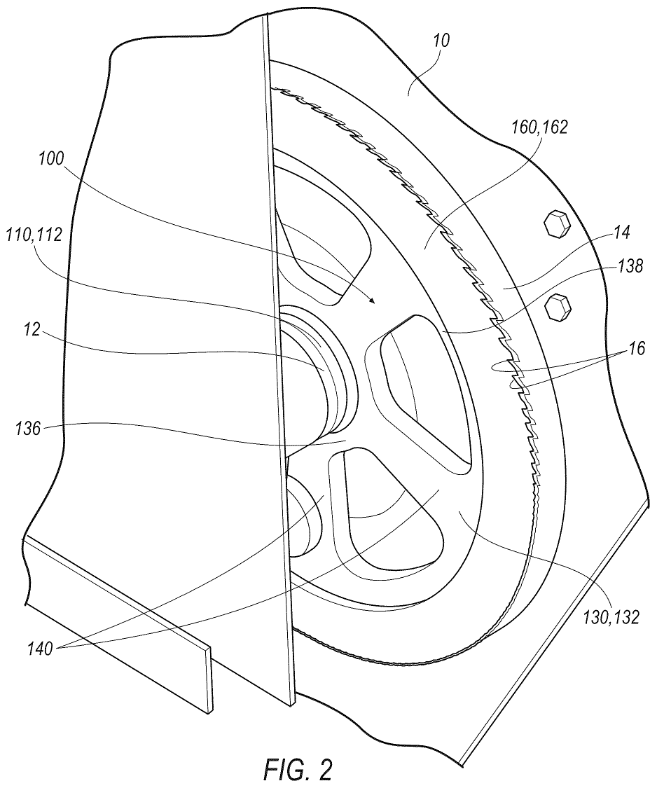

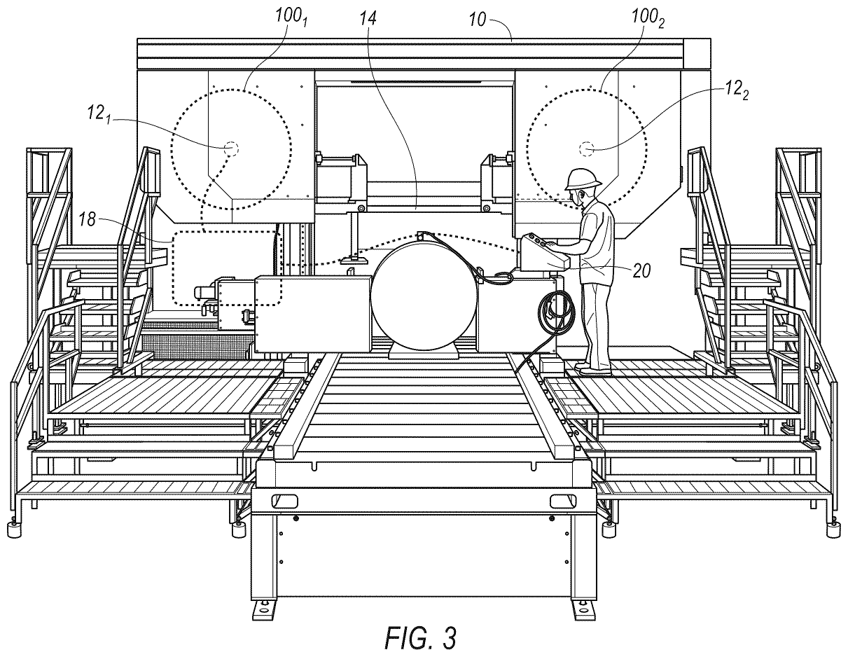

Referring to FIG. 1, an embodiment of a bandsaw wheel 100 having a wheel rotation axis 102, about which the bandsaw wheel 100 may be rotatable, is generally illustrated. FIG. 2 depicts a portion of a bandsaw 10 including a shaft 12 (e.g., a drive shaft or an undriven shaft), the bandsaw wheel 100 of FIG. 1 disposed and/or mounted on the shaft 12, and a blade 14 with serrations/teeth 16 disposed on and wrapped around an outer perimeter of the bandsaw wheel 100 (e.g., the outer circumferential surface of the rim 160). FIG. 3 depicts a front view of the bandsaw 10 of FIG. 2 that includes two bandsaw wheels 100₁, 100₂ of FIG. 1 that are each mounted on a respective shaft 12₁, 12₂, a motor 18 operatively connected to the shaft 12₁ for driving and/or rotating the bandsaw wheels 100₁, 100₂, and a controller 20 operatively (e.g., physically, electrically, communicatively, etc.) connected to at least the motor 18 via which the bandsaw 10 may be operable and/or controlled.

As generally illustrated in FIG. 1, the bandsaw wheel 100 includes a hub 110 composed of a first material, an intermediate body 130 composed of a second material, and a rim 160 composed of a third material. The hub 110, the rim 160, and the intermediate body 130 may be arranged coaxially with one another and the wheel rotation axis 102. The hub 110, the rim 160, and the intermediate body 130 may be provided as separate/individual bodies, components, and/or pieces that may be assembled and connected to one another to form and/or define the bandsaw wheel 100. As such, the bandsaw wheel 100 may be considered and/or referred to as a composite bandsaw wheel 100, a modular bandsaw wheel 100, and/or as having a modular construction. Alternatively, the bandsaw wheel 100 may conceivably be formed as a single, monolithic body and the portions of the monolithic body that define and/or form the hub 110, the intermediate body 130, and the rim 160 may be composed of different materials (e.g., the first material, the second material, and the third material). The first material, the second material, and the third material may comprise different materials and have one or more different properties (e.g., different elasticities, densities, and hardnesses). Conceivably, two or more of the first material, the second material, and the third material may be the same material.

Vibrations produced during operation of the bandsaw 10, particularly when sawing a material(s), may be generally transferred through the blade 14 into the bandsaw wheels 100₁, 100₂ due to the blade 14 being arranged on and/or wrapped partially around the bandsaw wheels 100₁, 100₂ under tension. These vibrations typically pass through and/or are transferred by the bandsaw wheels 100₁, 100₂, resulting in harmonic vibrations that increase the amount and/or level of noise produced by the bandsaw 10 during operation. Unlike traditional bandsaw wheels that may be generally formed/structured as a single, monolithic component composed of a single material, the disclosed bandsaw wheel 100, 100₁, 100₂ comprises multiple individual components (e.g., the hub 110, the intermediate body 130, and the rim 160) that may be each composed of different materials (e.g., the first, second, and third material). The (e.g., first) break, separation, and/or transition between the rim 160 and the intermediate body 130, as well as the (e.g., second) break, separation, and/or transition between the intermediate body 130 and the hub 110 interrupt the passage of vibrations through the bandsaw wheel 100 and effectively dampen the vibrations (e.g., the frequency of the vibration). Moreover, as the first, second, and/or third materials may be different from one another and have their own specific properties, characteristics, and/or qualities (e.g., frequency), the interruption and dampening of the vibrations may be further influenced and/or enhanced by the material change that occurs at each of the breaks, separations, and/or transitions (e.g., from the third material of the rim 160 to the second material of the intermediate body 130, from the second material of the intermediate body 130 to the first material of the hub 110). The disclosed bandsaw wheel 100 therefore achieves and/or provides enhanced and/or improved vibration dampening and, consequently, reduced resonance, harmonics, and noise generation during operation (e.g., relative to existing bandsaw wheels) due to its multi-component structure (e.g., its modular construction) and the different material compositions of the rim 160, the intermediate body 130, and the hub 110.

The bandsaw wheel 100 is mountable on and/or connectable to a shaft 12 (e.g., an undriven shaft and/or a drive shaft of a motor 18 of a bandsaw 10) via the hub 110 (see, e.g., FIG. 2). Due to the properties and characteristics of the first material of the hub 110 (for example as described further below), the operational capacity of the hub 110 significantly exceeds and may be more than sufficient to withstand the forces and/or stresses that the hub 110 typically experiences and/or may be subjected to during operation of the bandsaw 10, which provides the hub 110 and/or the bandsaw wheel 100 with an enhanced and/or increased useful, operational, and/or service life. The hub 110 may include a generally annular hub body 112 (e.g., a monolithic body) and a hub recess 114 that receives at least a portion of the shaft 12. The hub recess 114 may be disposed in and/or defined by the hub body 112 (e.g., an inner circumferential surface thereof). The hub body 112 (e.g., the inner circumferential surface thereof) is intended to engage and/or contact the shaft of a bandsaw 10. The hub body 112 (e.g., an outer circumferential surface thereof)may be disposed in and/or on and connected to the intermediate body 130 (e.g., the disc body 132) via a second shrink fit connection. The hub body 112 and the hub recess 114 may be arranged coaxially with one another and the wheel rotation axis 102.

The intermediate body 130 may be connected to, extend between, and connect the hub 110 and the rim 160. In other words, the hub 110 and the rim 160 may be connected to one another via the intermediate body 130. The intermediate body 130 may include a generally disc-shaped body 132 (e.g., a monolithic body), one or more spoke openings 142, and a central recess 134 that receives at least a portion of the hub 110 (e.g., the hub body 112). The disc body 132 may comprise a substantially planar body including a radially inner portion 136, a radially outer portion 138, and a plurality of spoke portions 140. The inner portion 136 and the outer portion 138 may each be annular (i.e., ring-shaped) and, thus, may also be considered and/or referred to as an inner annular portion 136 and an outer annular portion 138. The central recess 134 may be disposed in and defined by the inner annular portion 136 (e.g., an inner circumferential surface thereof). The inner annular portion 136 (e.g., the inner circumferential surface thereof) may be disposed on and connected to the hub body 112 (e.g., the outer circumferential surface thereof) via a second shrink fit connection. The outer annular portion 138 (e.g., an outer circumferential surface thereof) may be disposed on and connected to the rim 160 (e.g., the rim body 162) via a first shrink fit connection. The spoke portions 140 may extend between and connect the inner annular portion 136 and the outer annular portion 138. The spoke portions 140 may generally extend radially and linearly between the inner and outer annular portions 136, 138, but may alternatively have other shapes and/or configurations. The spoke openings 142 may be disposed between the inner annular portion 136 and the outer annular portion 138 and may be separated from one another by the spoke portions 140. As such, each spoke opening 142 may be defined by and between the inner annular portion 136, the outer annular portion 138, and a respective pair of adjacent spoke portions 140. In embodiments, the inner annular portion 136, the outer annular portion 138, and the central recess 134 may be arranged coaxially with one another and the wheel rotation axis 102.

The bandsaw wheel 100 engages and/or contacts a blade 14 of a bandsaw 10 via the rim 160 (see, e.g., FIG. 2). The rim 160 may include a generally annular rim body 162 (e.g., a monolithic body) and a rim recess 164 that receives at least a portion of the intermediate body 130. The rim recess 164 may be disposed in and/or defined by the rim body 162 (e.g., an inner circumferential surface thereof). The rim body 162 (e.g., the inner circumferential surface thereof) may be disposed on and connected to the intermediate body 130 (e.g., the disc body 132) via a first shrink fit connection. The rim body 162 (e.g., an outer circumferential surface thereof) is intended to engage and/or contact the blade 14 of a bandsaw 10. The rim body 162 and the rim recess 164 may be arranged coaxially with one another and the wheel rotation axis 102.

The rim 160, the intermediate body 130, and the hub 110 may be connected via shrink fit connections. The rim 160 and the intermediate body 130 may be connected to one another via a first shrink fit connection. The hub 110 and the intermediate body 130 may be connected to one another via a second shrink fit connection. Generally speaking, shrink fit connections can achieve and/or provide stronger and more secure connection/attachment of components than one or more other interference-type connections, such as press fit connections. For example, the first and second shrink fit connections of the bandsaw wheel 100 each provide a 0.008 to 0.020 inch interference fit. More specifically, the first shrink fit connection and/or the second shrink fit connection may provide a 0.008 to 0.020 inch interference fit, a 0.008 to 0.010 inch interference fit, 0.010 to 0.015 inch interference fit, or a 0.020 inch interference fit. Conversely, press fit connections utilized for bearings and other tight-fitting components typically provide up to about a 0.002 inch interference fit. An interference fit of the magnitude provided by the shrink fit connections of the bandsaw wheel 100 cannot be produced/achieved by a press fit connection since, for example, one or both of the components that are to be connected would fail (e.g., break and/or plastically deform) when attempting to establish the press fit connection.

The hub 110 and/or the hub body 112 may be composed of and/or includes the first material. The first material may be a metal, such as an alloy. The first material is typically a very strong, high-grade alloy material. In the illustrative example herein, the first material may be an alloy steel (e.g., high alloy steel). For example, the first material may be (i) a medium-carbon, low-alloy steel and/or (ii) an alloy steel including and/or containing nickel, chromium, and/or molybdenum. In one non-limiting example, the first material is 4330 alloy steel. The first material may be another suitable material, metal, and/or alloy in other exemplary bandsaw wheels 100.

The intermediate body 130 and/or the disc body 132 may be composed of and/or includes the second material. The second material may be a metal, such as an alloy. In the illustrative example herein, the second material may be a carbon steel (e.g., a low-carbon steel and/or a mild steel). In one non-limiting example, the second material is A36 steel. The second material may be another suitable material, metal, and/or alloy in other exemplary bandsaw wheels 100.

The rim 160 and/or the rim body 162 may be composed of and/or include the third material. The third material may be a metal, such as an alloy (e.g., a metal alloy). In the illustrative example herein, the third material may be an alloy steel, which may be different than the alloy steel used for the first material. For example, the third material may be an alloy steel including and/or containing chromium, molybdenum, and/or manganese. In one non-limiting example, the third material may be 4140 alloy steel. The third material may be another suitable material, metal, and/or alloy in other exemplary bandsaw wheels 100.

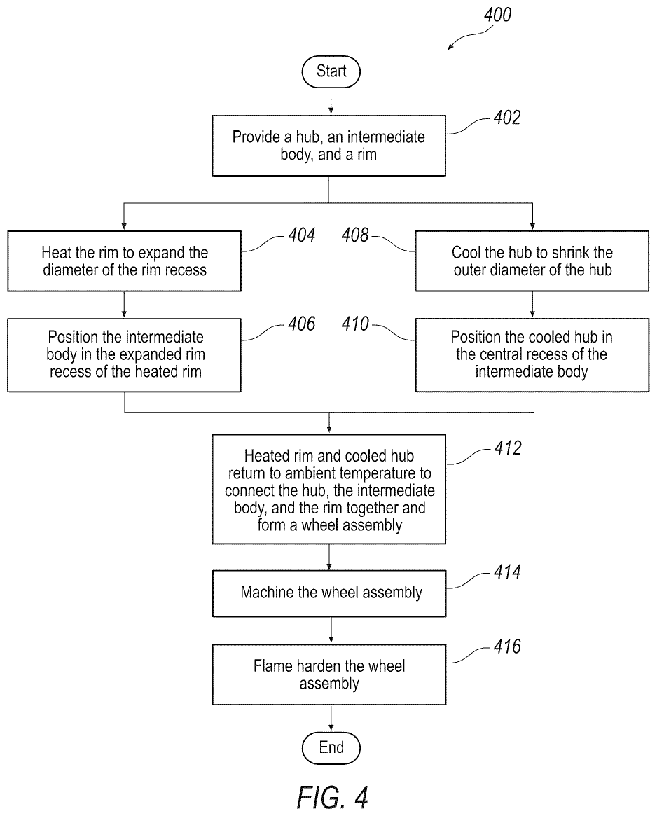

FIG. 4 depicts an exemplary method 400 of manufacturing a bandsaw wheel 100, such as the bandsaw wheel 100 of FIG. 1. Manufacturing the bandsaw wheel 100 includes providing a hub 110, an intermediate body 130, and a rim 160 (step 402). Next, the hub 110, the intermediate body 130, and the rim 160 may be connected together to form a wheel assembly (steps 404-412). Connecting the hub 110, the intermediate body 130, and the rim 160 includes connecting the rim 160 and the hub 110 to one another with the intermediate body 130 via (i) connecting the intermediate body 130 and the rim 160 to one another (steps 404, 406, 412) and (ii) connecting the intermediate body 130 and the hub 110 to one another (steps 408, 410, 412).

Connecting the rim 160 and the intermediate body 130 includes heating the rim 160 to expand and increase the size of the rim body 162, which in turn expands and/or increases the size (e.g., diameter) of the rim recess 164 (step 404). The rim 160 may be heated until the diameter D_{RR} of the rim recess 164 is larger than an outer diameter OD_{IB} of the intermediate body 130. In other words, the diameter D_{RR} of the rim recess 164 may be increased from an initial value/diameter D_{RR1} that is smaller than the outer diameter OD_{IB} of the intermediate body 130 to an expanded value/diameter D_{RR2} that is larger than the outer diameter OD_{IB} of the intermediate body 130 via heating the rim 160 (i.e., D_{RR1}<OD_{IB}<D_{RR2}). It should be noted that the diameter D_{RR} of the rim recess 164 may also be considered, referred to as, and/or substantially equivalent to an inner diameter ID_{R} of the rim 160 (i.e., D_{RR}=ID_{R}). Once the rim 160 has been sufficiently heated, the intermediate body 130 may be positioned, disposed, and/or arranged in the expanded rim recess 164 (i.e., having the expanded and/or increased diameter D_{RR2}) of the heated rim 160 (step 406), such as by inserting the intermediate body 130 in the expanded rim recess 164 and/or placing the heated rim 160 over the intermediate body 130. The heated rim 160 may then be cooled to approximately ambient temperature (step 412). The heated rim 160 may be cooled passively by simply allowing the heated rim 160 to cool and return to ambient temperature naturally. The heated rim 160 (e.g., the rim body 162 and the diameter D_{RR} of the rim recess 164) shrinks and/or returns back toward its original, unheated dimensions as it cools and returns to ambient temperature. The diameter D_{RR} of the rim recess 164 thus may decrease from the expanded value/diameter D_{RR2} toward the initial value/diameter D_{RR1} as the heated rim 160 cools and shrinks. Since the outer diameter OD_{IB} of the intermediate body 130 may be greater than the initial diameter D_{RR1} of the rim recess 164, the rim 160 (e.g., the inner circumferential surface thereof) may contact the outer circumferential surface of the intermediate body 130 as it cools and shrinks, which prevents further shrinking of the rim recess 164. The rim 160 contacts the intermediate body 130 before the rim 160 has finished cooling and/or returned to ambient temperature however, and thus the rim 160 continues to cool and shrink. The continued cooling and shrinking of the rim 160 causes the rim 160 (e.g., the inner circumferential surface thereof) to press radially inward against, squeeze, and/or constrict the outer circumferential surface of the intermediate body 130 thereby establishing a shrink fit connection between the rim 160 and the intermediate body 130. When the rim 160 has returned to ambient temperature and is connected to the intermediate body 130, the rim recess 164 may have a final diameter D_{RR3} that is approximately equal to the outer diameter OD_{IB} of the intermediate body 130 (i.e., D_{RR3}=OD_{IB}; D_{RR1}<D_{RR3}<D_{RR2}).

Connecting the hub 110 and the intermediate body 130 may include super cooling the hub 110 to shrink and decrease the size of the hub body 112 (step 408). The hub 110 may be cooled via subjecting the hub 110 to liquid nitrogen (e.g., at about negative 320 degrees Fahrenheit) such as by placing the hub 110 in a liquid nitrogen bath. The hub 110 may be cooled until the outer diameter OD_{H} of the hub 110 is smaller than the diameter D_{CR} of the central recess 134 of the intermediate body 130. In other words, the outer diameter OD_{H} of the hub 110 may be decreased from an initial value/diameter OD_{H1} that is larger than the diameter D_{CR} of the central recess 134 to a reduced value/diameter OD_{H2} that is smaller than the diameter D_{CR} of the central recess 134 via super cooling the hub 110 (i.e., OD_{H1}>D_{CR}>OD_{H2}). It should be noted that the diameter D_{CR} of the central recess 134 of the intermediate body 130 may also be considered, referred to as, and/or substantially equivalent to an inner diameter ID_{IB} of the intermediate body 130 (i.e., D_{CR}=ID_{IB}). Once the hub 110 has been sufficiently cooled, the cooled hub 110 (i.e., having the reduced and/or decreased diameter OD_{H2}) is positioned, disposed, and/or arranged in the central recess 134 of the intermediate body 130 (step 410), such as by inserting the cooled hub 110 in the central recess 134 and/or placing the intermediate body 130 over the cooled hub 110. The cooled hub 110 may then be warmed and/or heated up to approximately ambient temperature (step 412). The cooled hub 110 may be warmed up passively by simply allowing the cooled hub 110 to warm up and return to ambient temperature naturally. The cooled hub 110 (e.g., the hub body 112 and the outer diameter OD_{H} thereof) may expand and/or return back toward its original, uncooled dimensions as it returns to ambient temperature. The outer diameter OD_{H} of the hub 110 thus may increase from the reduced value/diameter OD_{H2} toward the initial value/diameter OD_{H1} as the cooled hub 110 warms up and expands. Since the initial outer diameter OD_{H1} of the hub 110 may be larger than the diameter D_{CR} of the central recess 134 of the intermediate body 130, the hub 110 (e.g., the outer circumferential surface thereof) may contact the inner circumferential surface of the intermediate body 130 as it warms up and expends, which prevents further expansion of at least a portion of the outer circumferential surface of the hub 110. The hub 110 contacts the intermediate body 130 before the hub 110 has finished warming up and/or returned to ambient temperature however, and thus the hub 110 may continue to warm up and expand. The continued warming up and expansion of the hub 110 may cause the hub 110 (e.g., the outer circumferential surface thereof) to press radially outward against the inner circumferential surface of the intermediate body 130 thereby establishing a shrink fit connection between the hub 110 and the intermediate body 130. When the hub 110 has returned to ambient temperature and is connected to the intermediate body 130, the hub 110 may have a final outer diameter OD_{H3} that is approximately equal to the diameter D_{CR} of the central recess 134 of the intermediate body 130 (i.e., OD_{H3}=D_{CR}; OD_{H1}>OD_{H3}>OD_{H2}).

In the exemplary method 400 of FIG. 4, the intermediate body 130 and the rim 160 may be connected together and the intermediate body 130 and the hub 110 may be connected together at substantially the same time (e.g., simultaneously). This allows the rim 160 to be heated while the hub 110 is being cooled (i.e., steps 404 and 408 to be performed in parallel and/or simultaneously), the heated rim 160 and the cooled hub 110 to be positioned relative to the intermediate body 130 simultaneously or one after another in quick succession (i.e., steps 406 and 410 to be performed simultaneously and/or in quick succession), and the heated rim 160 and the cooled hub 110 to return to ambient temperature simultaneously (i.e., performance of step 412 once rather than twice - once to connect the rim 160 and once to connect the hub 110), which reduces the overall time to manufacture the bandsaw wheel 100. In other examples, the intermediate body 130 and the rim 160 may be connected together (steps 404, 406, 412) and the intermediate body 130 and the hub 110 may be connected together (steps 408, 410, 412) in series (i.e., one after another with step 412 being performed twice). In such examples, the intermediate body 130 and the rim 160 can be connected together (steps 404, 406, 412) before or after connecting the intermediate body 130 and the hub 110 together (steps 408, 410, 412). Optionally, the heated rim 160 may be actively cooled (e.g., via providing an air stream/current, placing the heated rim 160 in a cooled and/or temperature-controlled environment, etc.) and/or the cooled hub 110 may be actively heated (e.g., via providing a fluid flow of heated fluid, placing the cooled hub 110 in a heated and/or temperature-controlled environment, etc.) to expediate returning to ambient temperature during step 412. If utilized, active cooling and/or heating should be controlled and/or monitored closely as changing the temperature of the rim 160 and/or the hub 110 too rapidly could potentially influence and/or change the material microstructure of the rim 160 and/or the hub 110 in an undesirable manner.

The method 400 further includes machining the wheel assembly (step 414). Machining the wheel assembly includes removing material from and/or shaping one or more portions of the wheel assembly (e.g., via grinding the wheel assembly) to the desired shape and dimensions. Optionally, after machining the wheel assembly, the rim 160 and the intermediate body 130 may be welded together and the hub 110 and the intermediate body 130 may be welded together. This welding may further connect the rim 160, the intermediate body 130, and the hub 110 together, but may be primarily cosmetic (e.g., to provide visual connections for users and/or customers).

The method 400 may further include flame hardening the wheel assembly (step 416) to, for example, achieve the final, completed bandsaw wheel 100. Flame hardening the wheel assembly may include hardening the rim 160, the wheel assembly, and/or an outer circumferential region of the rim 160 and/or of the wheel assembly to have a hardness of approximately 48-60 RC. Flame hardening the wheel assembly and/or the rim 160 may enhance and/or increase the useful, operational, and/or service life of the final bandsaw wheel 100.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

It should be understood that the controller 20 includes an electronic controller and/or includes an electronic processor, such as a programmable microprocessor and/or microcontroller. The controller 20 may also include an application specific integrated circuit (ASIC), a central processing unit (CPU), a memory (e.g., a non-transitory computer-readable storage medium), and/or an input/output (I/O) interface. The controller 20 is configured to perform various functions, including those described in greater detail herein, with appropriate programming instructions and/or code embodied in software, hardware, and/or other medium. The controller 20 is, optionally, connected to a display, such as a touchscreen display.

It should be understood that a controller (e.g., controller 20), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A bandsaw wheel, comprising:
a hub;
a rim; and
an intermediate body extending between and connecting the hub and the rim;
wherein the hub, the rim, and the intermediate body are separate, individual components.

2. The bandsaw wheel of claim 1, wherein the rim and the intermediate body are connected to one another via a shrink fit connection.

3. The bandsaw wheel of claim 1, wherein the hub and the intermediate body are connected to one another via a shrink fit connection.

4. The bandsaw wheel of claim 1, wherein:
the intermediate body includes a disc-shaped body having a radially inner annular portion, a radially outer annular portion, and a plurality of spoke portions extending between and connecting the inner annular portion and the outer annular portion;
the rim and the outer annular portion of the intermediate body are connected to one another via a first shrink fit connection;
the hub and the inner annular portion of the intermediate body are connected to one another via a second shrink fit connection.

5. The bandsaw wheel of claim 4, wherein at least one of the first shrink fit connection and the second shrink fit connection provide a 0.008 to 0.020 inch interference fit.

6. The bandsaw wheel of claim 1, wherein:
the hub is composed of a first material;
the intermediate body is composed of a second material;
the rim is composed of a third material; and
the first material, the second material, and the third material are different materials.

7. A bandsaw wheel, comprising:
a hub composed of a first material;
an intermediate body composed of a second material; and
a rim composed of a third material;
wherein the intermediate body extends between and connects the hub and the rim; and
wherein at least two of the hub, the intermediate body, and the rim are comprised of different materials.

8. The bandsaw wheel of claim 7, wherein the first material, the second material, and the third material are comprised of different materials.

9. The bandsaw wheel of claim 7, wherein:
the first material comprises a first alloy steel;
the second material comprises a carbon steel; and
the third material comprises a second alloy steel that is different than the first alloy steel.

10. The bandsaw wheel of claim 9, wherein:
the first alloy steel includes nickel, chromium, and molybdenum;
the carbon steel is a mild steel; and
the second alloy steel includes chromium, molybdenum, and manganese.

11. The bandsaw wheel of claim 7, wherein the hub, the rim, and the intermediate body are provided as separate, individual components.

12. The bandsaw wheel of claim 11, wherein the intermediate body is connected to at least one of the rim and the hub via a shrink fit connection.

13. The bandsaw wheel of claim 7, wherein:
the intermediate body includes a disc-shaped body having a radially inner annular portion, a radially outer annular portion, and a plurality of spoke portions extending between and connecting the inner annular portion and the outer annular portion;
the rim and the outer annular portion of the intermediate body are connected to one another via a first shrink fit connection; and
the hub and the inner annular portion of the intermediate body are connected to one another via a second shrink fit connection.

14. A method of manufacturing a bandsaw wheel, comprising:
providing a hub, an intermediate body, and a rim that are provided as separate, individual components; and
forming a wheel assembly via connecting the hub, the intermediate body, and the rim;
wherein connecting the hub, the intermediate body, and the rim includes (i) connecting the intermediate body and the rim to one another and (ii) connecting the intermediate body and the hub to one another.

15. The method of claim 14, wherein:
connecting the intermediate body and the rim to one another includes establishing a first shrink fit connection; and
connecting the intermediate body and the hub to one another includes establishing a second shrink fit connection.

16. The method of claim 15, wherein establishing the first shrink fit connection includes:
expanding a diameter of a rim recess of the rim via heating the rim;
positioning the intermediate body in an expanded rim recess of the heated rim; and
cooling the heated rim.

17. The method of claim 15, wherein establishing the second shrink fit connection includes:
reducing an outer diameter of the hub via super cooling the hub;
positioning the cooled hub in a central recess of the intermediate body; and
warming up the cooled hub.

18. The method of claim 17, wherein super cooling the hub includes subjecting the hub to liquid nitrogen.

19. The method of claim 15, wherein at least one of establishing the first shrink fit connection and establishing the second shrink fit connection includes producing a 0.008 to 0.020 inch interference fit.

20. The method of claim 14, further comprising:
machining the wheel assembly to shape the wheel assembly; and
flame hardening at least a portion of the rim to have a hardness of 48-60 RC.
